(19) United States
(12) Patent Application Publication
(10) Pub. No.: US 2005/0223345 A1
(43) Pub. Date: Oct. 6, 2005

(54) Circuit design assistant system, circuit design method, and program product for circuit design

(75) Inventor: Shinya Furusawa, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/094,315

(22) Filed: Mar. 31, 2005

(30) Foreign Application Priority Data
Apr. 1, 2004 (JP) 2004-108988

(51) Int. Cl. G06F 17/50

(52) U.S. Cl. 716/4; 716/18

(57) ABSTRACT

The computer program product according to an embodiment of the invention causes a computer to execute the process including acquiring circuit information generated by behavioral synthesis, determining an active condition of a net, determining an active condition of an alternate path, determining an active condition of an alternate data path, determining an active condition of each path, and detecting a false path.

### BACKGROUND OF THE INVENTION

1. Field of the Invention

The present invention relates to a circuit design assistant system, a circuit design method, and a program product, and more particularly, to a circuit design assistant system, a circuit design method, and a program product for circuit design using behavioral synthesis.

2. Description of Related Art

A semiconductor circuit such as a large-scale integrated circuit (LSI) is manufactured in a manufacturing process after a series of design processes including system design, functional design, logic design, and layout design. The design processes use various design assistant systems and programs for the design of a large-scale integrated circuit or the like.

Each design process (design level) uses optimal description to clarify the configuration. For example, the functional design uses behavioral description that does not include hardware configuration but describes behavior only, register transfer level (RTL) description that describes a data path and a control circuit which are composed of a combinational circuit, a register and soon. The logic design uses a netlist or the like that describes summary of connections between logic gates.

In a conventional circuit design method, a designer first describes an RTL system in Verilog Hardware Description Language (Verilog-HDL), VHSIC Hardware Description Language (VHDL) and so on. Then, a netlist is generated through the usage of logic synthesis. In order to enhance the design efficiency, a recent trend is that a designer describes a behavior description in C language, System C and so on, and then the behavior description is transformed into an RTL description system by behavioral synthesis, which is also called high-level synthesis.

The logic synthesis includes timing verification to check if a circuit normally operates in synchronization with a clock, using a netlist generation tool, a static timing analysis (STA) tool, and so on. The timing verification is performed based on data paths. A data path is composed of instances such as a computing unit, a register and a multiplexer, and nets connecting the instances. The timing verification is performed for each path (signal path) composed of a plurality of nets, also called transfer paths, so as to detect the path operating over a clock cycle as a delay error. The path with the delay error is referred to as a critical path.

In a circuit which changes state, a path that includes the nets which are not simultaneously activated in all the states can exist. Such a path is called a false path, and a path that includes the nets which are simultaneously activated in any one of states is referred to as a true path. The net which is not activated is a net where data is not transferred.

A logically synthesized circuit normally operates no matter how large the delay of the false path is as long as the delay constraints of the true path are satisfied. However, since the netlist generation tool, the STA tool, an automatic placer and router and so on cannot identify between true paths and false paths, they perform timing verification, optimization and soon for the false path as well. This causes the problems such as a longer logic synthesis processing time, a larger circuit area, and generation of a delay report including unnecessary critical path.

To avoid the above problems, it is set to the netlist generation tool or the like which path is a false path to prevent the tool from performing logic synthesis and timing verification on the false path. As a method for setting information on a false path to the netlist generation tool or the like, a technique of extracting a false path from circuit information after behavior synthesis is described in Japanese Unexamined Patent Application Publication No. 2001-209670 and 2002-342403, for example.

FIG. 16 shows a conventional circuit design assistant system which extracts a false path. The circuit design assistant system 1100 synthesizes a behavioral description and extracts a false path based on the behaviorally synthesized circuit information. The circuit design assistant system 1100 has a behavioral description storage unit 1101, a behavioral synthesis unit 1102, a behaviorally synthesized circuit information storage unit 1103, a false path extraction unit 1120, and a false path information storage unit 1104. The false path extraction unit 1120 has an active condition setting unit 1121, circuit information with active condition storage unit 1122, a false path search unit 1125, an active path information storage unit 1126, and a transfer path information storage unit 1127.

The behavioral synthesis unit 1102 synthesizes a behavioral description stored in the behavioral description storage unit 1101 and generates an RTL circuit. The behavioral synthesis unit 1102 stores a data flow graph, resource allocation information, a data path and a control circuit constituting the RTL circuit, which are generated during the course of behavioral synthesis process, into the behaviorally synthesized circuit information storage unit 1103.

The active condition setting unit 1121 extracts the condition for activating each net constituting the data path based on the data flow graph, the resource allocation information, the data path and the control circuit, and stores the nets associated with the active conditions into the circuit information with active condition storage unit 1122.

The false path search unit 1125 performs AND operation of the active conditions of the nets included in the path based on the active condition associated with the net which is stored in the circuit information with active condition storage unit 1122, and determines if the path is a false path. The false path search unit 1125 stores the path determined to be a false path into the false path information storage unit 1104. In the process of searching for a false path, the false path search unit 1125 stores the active path which serves as the starting point of search into the active path information storage unit 1126 and stores the net to be searched onward into the transfer path information storage unit 1127.

The false path is set to a netlist generation tool or the like based on the information in the false path information storage unit 1104. When setting the false path to a netlist generation tool, an STA tool, an automatic placer and router and so on, the false path is identified by specifying the instances of the RTL circuit. Therefore, the false path information storage unit 1104 stores only the instances which are included in the false path.

When identifying a path by the instances, the specified instances can constitute a plurality of paths. Thus, the true path may be included in the paths identified by the specified instances which are to identify a false path.

FIG. 17 shows the case where the false path identification includes a true path. In FIG. 17, R1 to R4 designate instances, and C1 to C4 designate active conditions. The path a and path b are paths from R1 through R3. Since the active condition of the path a is C1*C2=0 where the symbol “*” represents AND operation, the path a is determined as a false path. Further, since the active condition of the path b is C1*C3*C4≈0, the path b is determined as a true path. In this case, if the path a, which is the false path, is specified by the instances, it is: R1-R2-R3. The identification undesirably includes the path b, R1-R2-R4-R3, which is a true path.

The netlist generation tool, STA tool, automatic placer and router and so on do not perform processes such as timing verification and optimization on the above mentioned path composed of the specified instances since they recognize the path as a false path. Thus, if the instances identifying a false path constitute a true path as described above, the timing verification and optimization are not performed on the true path as well.

A technique of allocating a computing unit so as not to cause delay error in false paths in behavioral synthesis is described in Japanese Unexamined Patent Application Publication No. 2003-76728, for example.

As described in the foregoing, the present invention has recognized that a conventional circuit design assistant system fails to correctly perform timing verification, optimization and so on due to its low false path detection accuracy when using data of path specifying instances.

### SUMMARY OF THE INVENTION

According to one aspect of the present invention, there is provided a computer program product, in a computer readable medium, which causes a computer to execute a process of detecting a false path from a data path having a plurality of paths including a plurality of transfer paths, the process comprising: acquiring circuit information generated by behavioral synthesis and a data path corresponding to the circuit information; determining an active condition for transferring data for each of the plurality of transfer paths included in the data path based on the circuit information; determining an active condition of an alternate path bypassing a transfer path and transferring data for each of the plurality of transfer paths based on the active condition of the transfer path; determining an active condition of an alternate data path composed of a transfer path and an alternate path of the transfer path based on the active condition of the transfer path and the active condition of the alternate path; determining an active condition of each of a plurality of paths included in the data path based on the active condition of the transfer path and the active condition of the alternate data path; and detecting a false path based on the active condition of the path. This computer program product determines an active condition of an alternate path when a data path having the alternate path exists, thereby determining the active condition of the data path including the active condition of the alternate path. By detecting a false path based on this active condition, it is possible to detect a false path accurately even if the data path is identified by instances. This allows performing timing verification, optimization, and so on without fail.

According to another aspect of the present invention, there is provided a computer program product, in a computer readable medium, which causes a computer to execute a process of eliminating a false path from delay information including a plurality of critical paths, the process comprising: acquiring circuit information generated by behavioral synthesis and delay information generated from the circuit information by timing verification; determining an active condition for transferring data for each of the plurality of critical paths included in the delay information based on the circuit information; detecting whether each critical path is a false path based on the active condition; and eliminating the critical path from the delay information if the critical path is a false path. This computer program product determines an active condition for each critical path included in delay information, thereby detecting a false path accurately and eliminating it. It is thereby possible to generate accurate delay information (delay report) without including any false path.

According to another aspect of the present invention, there is provided a design method for detecting a false path from a data path having a plurality of paths including a plurality of transfer paths, the method comprising: acquiring circuit information generated by behavioral synthesis and a data path corresponding to the circuit information; determining an active condition for transferring data for each of the plurality of transfer paths included in the data path based on the circuit information; determining an active condition of an alternate path bypassing a transfer path and transferring data for each of the plurality of transfer paths based on the active condition of the transfer path; determining an active condition of an alternate data path composed of a transfer path and an alternate path of the transfer path based on the active condition of the transfer path and the active condition of the alternate path; determining an active condition of each of a plurality of paths included in the data path based on the active condition of the transfer path and the active condition of the alternate data path; and detecting a false path based on the active condition of the path. This design method determines an active condition of an alternate path when a data path having the alternate path exists, thereby determining the active condition of the data path including the active condition of the alternate path. By detecting a false path based on this active condition, it is possible to detect a false path accurately even if the data path is identified by instances. This allows performing timing verification, optimization, and so on without fail.

According to one aspect of the present invention, there is provided a design method for eliminating a false path from delay information including a plurality of critical paths, the method comprising: acquiring circuit information generated by behavioral synthesis and delay information generated from the circuit information by timing verification; determining an active condition for transferring data for each of the plurality of critical paths included in the delay information based on the circuit information; detecting whether each critical path is a false path based on the active condition; and eliminating the critical path from the delay information if the critical path is a false path. This design method determines an active condition for each critical path included in delay information, thereby detecting a false path accurately and eliminating it. It is thereby possible to generate accurate delay information (delay report) without including any false path.

According to another aspect of the present invention, there is provided a circuit design assistant system for detecting a false path from a data path having a plurality of paths including a plurality of transfer paths, the system comprising: a circuit information acquiring unit of acquiring circuit information generated by behavioral synthesis and a data path corresponding to the circuit information; a transfer path active condition determination unit of determining an active condition for transferring data for each of the plurality of transfer paths included in the data path based on the circuit information; an alternate path active condition determination unit of determining an active condition of an alternate path bypassing a transfer path and transferring data for each of the plurality of transfer paths based on the active condition of the transfer path; an alternate data path active condition determination unit of determining an active condition of an alternate data path composed of a transfer path and an alternate path of the transfer path based on the active condition of the transfer path and the active condition of the alternate path; a path active condition determination unit of determining an active condition of each of a plurality of paths included in the data path based on the active condition of the transfer path and the active condition of the alternate data path; and a false path detection unit of detecting a false path based on the active condition of the path. This circuit design assistant system determines an active condition of an alternate path when a data path having the alternate path exists, thereby determining the active condition of the data path including the active condition of the alternate path. By detecting a false path based on this active condition, it is possible to detect a false path accurately even if the data path is identified by instances. This allows performing timing verification, optimization, and so on without fail.

According to another aspect of the present invention, there is provided a circuit design assistant system for eliminating a false path from delay information including a plurality of critical paths, the system comprising: a circuit information acquiring unit of acquiring circuit information generated by behavioral synthesis and delay information generated from the circuit information by timing verification; an active condition determination unit of determining an active condition for transferring data for each of the plurality of critical paths included in the delay information based on the circuit information; a false path detection unit of detecting whether each critical path is a false path based on the active condition; and a false path elimination unit of eliminating the critical path from the delay information if the critical path is a false path. This circuit design assistant system determines an active condition for each critical path included in delay information, thereby detecting a false path accurately and eliminating it. It is thereby possible to generate accurate delay information (delay report) without including any false path.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing the configuration example of a circuit design assistant system of the invention;

FIG. 2 is a diagram showing an example of data of behavioral description used in the circuit design assistant system of the invention;

FIG. 3 is a diagram showing an example of data of data flow graph used in the circuit design assistant system of the invention;

FIG. 4 is a diagram showing an example of data of a control circuit used in the circuit design assistant system of the invention;

FIG. 5 is a diagram showing an example of data of a data path used in the circuit design assistant system of the invention;

FIG. 6 is a diagram showing an example of data of circuit information with active condition used in the circuit design assistant system of the invention;

FIG. 7 is a diagram showing an example of data of circuit information with active condition used in the circuit design assistant system of the invention;

FIG. 8 is a diagram showing an example of data of circuit information with active condition used in the circuit design assistant system of the invention;

FIG. 9 is a diagram showing an example of data of circuit information with alternate path condition used in the circuit design assistant system of the invention;

FIG. 10 is a diagram showing an example of data of circuit information with alternate path condition used in the circuit design assistant system of the invention;

FIG. 11 is a diagram showing an example of data of circuit information with alternate path condition used in the circuit design assistant system of the invention;

FIG. 12 is a flowchart showing an alternate path condition setting process of the invention;

FIGS. 13A and 13B are diagrams showing examples of a search path list used in the alternate path condition setting process of the invention;

FIG. 14 is a block diagram showing the configuration example of a circuit design assistant system of the invention;

FIG. 15 is a hardware configuration diagram of a circuit design assistant system of the invention;

FIG. 16 is a block diagram showing the configuration example of a conventional circuit design assistant system; and

FIG. 17 is a diagram showing an example of a data path of a conventional circuit design assistant system.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed. It is noted that in the description of the drawings the same elements will be denoted by the same reference symbols and redundant description will be omitted.

### First Embodiment

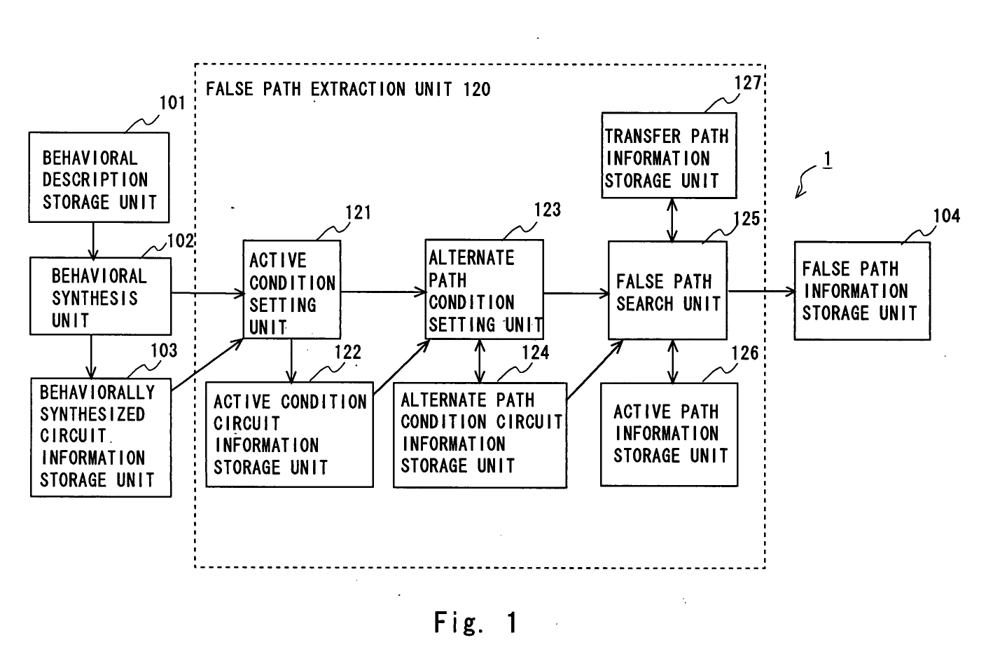

The configuration of a circuit design assistant system according to a first embodiment of the present invention is described hereafter with reference to the schematic block diagram of FIG. 1. The circuit design assistant system 1 synthesizes a behavioral description and accurately extracts a false path based on the behaviorally synthesized circuit information. The circuit design assistant system 1 is realized by a computer such as a personal computer or a server computer, and each block of FIG. 1 is realized by hardware or software executed on hardware. The circuit design assistant system 1 may be realized by a single or a plurality of computers.

The circuit design assistant system 1 has a behavioral description storage unit 101, a behavioral synthesis unit 102, a behaviorally synthesized circuit information storage unit 103, a false path extraction unit 120, and a false path information storage unit 104. The false path extraction unit 120 has an active condition setting unit 121, a circuit information with active condition storage unit 122, an alternate path condition setting unit 123, a circuit information with alternate path condition storage unit 124, a false path search unit 125, an active path information storage unit 126, and a transfer path information storage unit 127.

The circuit design assistant system 1 may further have an input device such as a keyboard and a mouse and a display device such as CRT and LCD, so that a user can enter information and each processing result is displayed for the user. For example, it is possible to use the input unit for receiving information from the user without the behavioral description storage unit 101 and, and use the display unit for displaying the processing result for the user without the false path information storage unit 104.

The behavioral synthesis unit 102, the active condition setting unit 121, the alternate path condition setting unit 123, and the false path search unit 125 may be realized by a CPU or the like executing processing according to application program stored in a memory in cooperation with other hardware configuration, for example. The behavioral description storage unit 101, the behaviorally synthesized circuit information storage unit 103, the circuit information with active condition storage unit 122, the circuit information with alternate path condition storage unit 124, the active path information storage unit 126, and the false path information storage unit 104 may be realized by an internal memory such as a hard disk or an external memory such as an optical disk.

The behavioral description storage unit 101 stores behavioral descriptions. A behavioral description is written in C language, for example. The behavioral descriptions are entered through the input device by a user such as a designer and stored in the behavioral description storage unit 101.

The behaviorally synthesized circuit information storage unit 103 stores a data flow graph, information on data paths and a control circuit (FSM) constituting an RTL circuit, resource allocation information, and so on. The information is generated by the behavioral synthesis unit 102 and stored in the behaviorally synthesized circuit information storage unit 103. The data flow graph indicates an operation execution sequence regarding the variables and operations of a behavioral description. The data path is a circuit where a computing unit, a register and so on are allocated according to the data flow graph. The control circuit controls data flow on the data path and operations according to the data flow graph. The resource allocation information is data which associates the element of the data flow graph and the element of the data path.

The behavioral synthesis unit 102 derives a behavioral description from the behavioral description storage unit 101 and synthesizes the behavioral description into an RTL circuit (RTL description). For example, the behavioral synthesis unit 102 generates a data flow graph according to the input behavioral description and schedules/allocates the data flow graph to create a data path as well as a control circuit, resource allocation information and so on. Then, the behavioral synthesis unit 102 stores the generated data flow graph, data path, information on the control circuit, and resource allocation information into the behaviorally synthesized circuit information storage unit 103.

The circuit information with active condition storage unit 122 stores circuit information with active condition, which is described later. The circuit information with active condition is data which associates each net constituting a part of path included in a data path to the active condition of the net. The circuit information with active condition is generated by the active condition setting unit 121 and stored in the circuit information with active condition storage unit 122.

The active condition setting unit 121 extracts the condition for activating each of nets constituting the path included in the data path based on the data flow graph, data path, control circuit, and resource allocation information stored in the behaviorally synthesized circuit information storage unit 103. Then, it associates the active condition to the net to generate the circuit information with active condition and stores it into the circuit information with active condition storage unit 122. The active condition setting unit 121 serves as a circuit information acquiring unit which acquires circuit information generated by the behavioral synthesis, such as data flow graph and resource allocation information, and data path corresponding to the circuit information. The active condition setting unit 121 also serves as a transfer path active condition determination unit which determines the active condition of the transfer path, which is also referred to as net, included in the data path.

For example, the active condition setting unit 121 reads out the data flow graph, data path, control circuit, and resource allocation information stored in the behaviorally synthesized circuit information storage unit 103. The active condition setting unit 121 then specifies the data flow corresponding to each net in the data path based on the resource allocation information. After that, it obtains the condition where data flows through the net based on the state, branch and so on of the data flow and determines the logical formula that represents the condition. The active condition setting unit 121 then associates the logical formula to each net to generate circuit information with active condition and stores it into the circuit information with active condition storage unit 122.

The circuit information with alternate path condition storage unit 124 stores circuit information with alternate path condition, which is described later. The circuit information with alternate path condition is data where active condition of an alternate path of a net included in a data path is added to the active condition associated with the net. It is generated by the alternate path condition setting unit 123 and stored in the circuit information with alternate path condition storage unit 124.

The alternate path condition setting unit 123 searches all the paths between the instances at the start and the end of each net associated with active condition based on the circuit information with active conditions stored in the circuit information with active condition storage unit 122. It then adds the active conditions of those paths to the active condition of the net to generate circuit information with alternate path condition and stores it into the circuit information with alternate path condition storage unit 124. The processing of the alternate path condition setting unit 123 is detailed later. The alternate path condition setting unit 123 serves as an alternate path active condition determination unit which determines the active condition of the alternate path that bypasses the net based on the active condition of the net. It also serves as an alternate data path active condition determination unit which determines the active condition of the alternate data path composed of the net and the alternate path based on the active condition of the net and the active condition of the alternate path.

The active path information storage unit 126 stores active path information, which is information about the active path serving as the search target and the starting point of search by the false path search unit 125. The transfer path information storage unit 127 stores transfer path information, which is information about the net searched onward by the false path search unit 125.

The false path information storage unit 104 stores false path information. The false path information contains a false path composed of nets and defined by specified instances. The false path information is generated by the false path search unit 125 and stored in the false path information storage unit 104. The false path information allows specifying the false path for a netlist generation tool, STA tool, automatic placer and router and so on.

The false path search unit 125 retrieves a false path from the circuit information with alternate path condition stored in the circuit information storage unit with alternate path condition 124, and outputs the retrieved false path to the false path information storage unit 104. The false path search unit 125 serves as a path active condition determination unit which determines the active condition of each path included in the data path based on the active condition of the net and the active condition of the alternate data path. It also serves as a false path detection unit which detects the false path based on the active condition of each path.

For example, the false path search unit 125 processes all the nets included in the data path based on the circuit information with alternate path condition stored in the circuit information with alternate path condition storage unit 124. First, the false path search unit 125 reads out the data of all the nets included in the data path from the circuit information with alternate path condition. Then, it searches the nets to find a net of which instances at the input side is an input terminal or a memory element, and then identifies all the nets and their active conditions. Then, it couples an searched net to another net to establish a path. After that, the false path search unit 125 performs AND operation of the active condition of each net included in the established path, thereby determining if the path is a true path or a false path. If the AND operation results in 0, the established path is determined to be a false path, and if it results in not 0, the established path is determined to be a true path. If the path is a false path, the instances of the path are stored into the false path information storage unit 104. If, on the other hand, the path is a true path, another net is further coupled thereto to establish a path anew, thereby determining if the newly established path is a true path or a false path.

Specifically, the false path search unit 125 stores the data of all the nets read out from the circuit information with alternate path condition storage unit 124 into the active path information storage unit 126. It then retrieves a net one by one to search a path including the net. Further, the false path search unit 125 stores all the nets connected to the instance at the input side of a net retrieved from the active path information storage unit 126 into the transfer path information storage unit 127. It retrieves a net one by one to establish a path with the net retrieved from the active path information storage unit 126, thereby detecting a false path.

Though this example searches for a false path by connecting another net to the input side of a given net, it is also possible to search for a false path in the opposite direction by connecting another net to the output side of a given net.

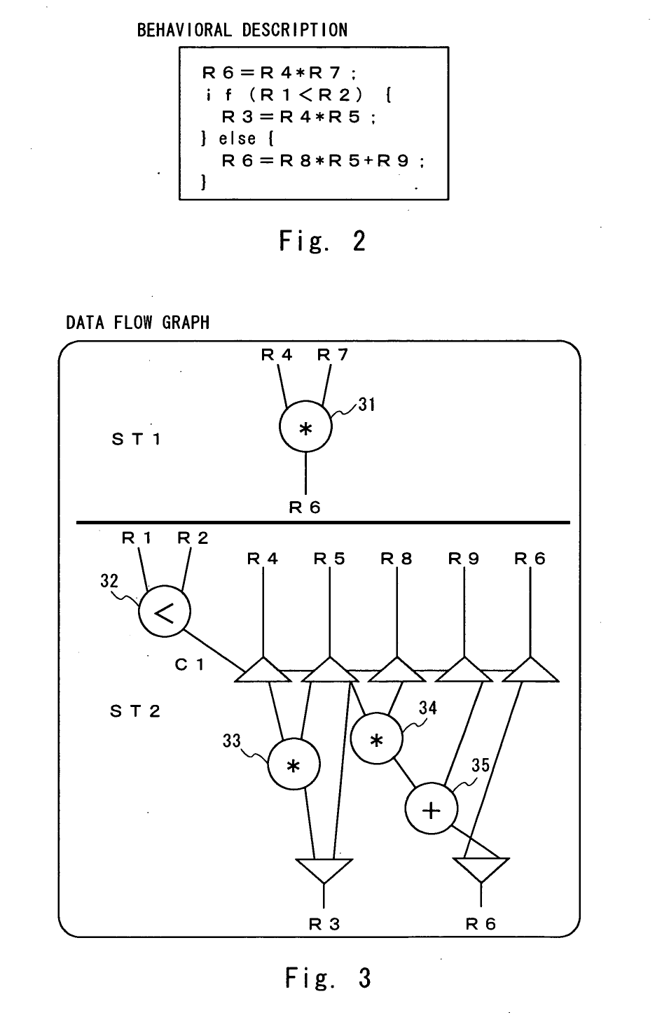

Examples of the data stored in each information storage unit shown in FIG. 1 are described hereafter with reference to FIGS. 2 to 13.

FIG. 2 shows an example of behavioral description stored in the behavioral description storage unit 101. The behavioral description represents the circuit behavior, and it is written in C language, for example. It may be written in System C, Spec C, ANSI-C, a derivative language of those, System Verilog, and so on. In the example of FIG. 2, the behavior is described with step lines sequentially performed from the first line, and R1 to R9 represent data or variables. According to this behavioral description, at the first line, R4 and R7 are multiplied and the product is assigned to R6. At the second line, it is determined whether R2 is larger than R1. If the determination is true, at the third line, R4 and R5 are multiplied and the result is assigned to R3. If, on the other hand, the determination is false, at the fifth line, R8 and R5 are multiplied and R9 is added thereto, and the result is assigned to R6. FIGS. 3 to 13 show examples of the data processed and stored by each unit according to the behavioral description of FIG. 2.

FIG. 3 shows an exemplary data flow graph generated from the behavioral description of FIG. 2. The data flow graph is composed of nodes and branches. The branch represents data and the node represents operation. The branch connected to the upper side of the node is an operation input branch and the branch connected to the lower side of the node is an operation output branch.

In the data flow graph of FIG. 3, R1 to R9 indicate the same data as in FIGS. 2, and 31 to 35 indicate each operation of FIG. 2. C1 is the data as a result of the operation 32 of R1 and R2, which is comparison operation in this case. In the data flow graph, the operation at each node is related to a clock cycle by scheduling in the behavioral synthesis. This example is scheduled so as to perform each of states ST1 and ST2 in one cycle.

In this data flow graph shown in FIG. 3, R4 and R7 are input data to the operation 31 and the operation result is provided as R6. This behavior corresponds to the first line of FIG. 2, and it is allocated to the state ST1. R1 and R2 are input data to the operation 32 and the output operation result is C1. This behavior corresponds to the second line of FIG. 2, and it is assigned to the state ST2. The third and subsequent lines of FIG. 2 are also allocated to the state ST2.

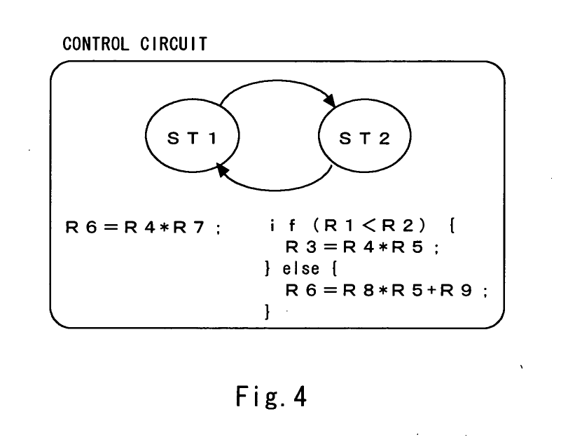

FIG. 4 shows an example of a control circuit generated from the data flow graph of FIG. 3. The control circuit is described with a state machine which indicates the state transition of the data path generated from the same data flow graph. The controller of example controls the data path so as to the operation of the state ST1 of FIG. 3, which is the operation of the first line of FIG. 2, is performed in the state ST1, and the operation of the state ST2 of FIG. 3, which is the operation of the second and subsequent lines of FIG. 2, are performed in the state ST2.

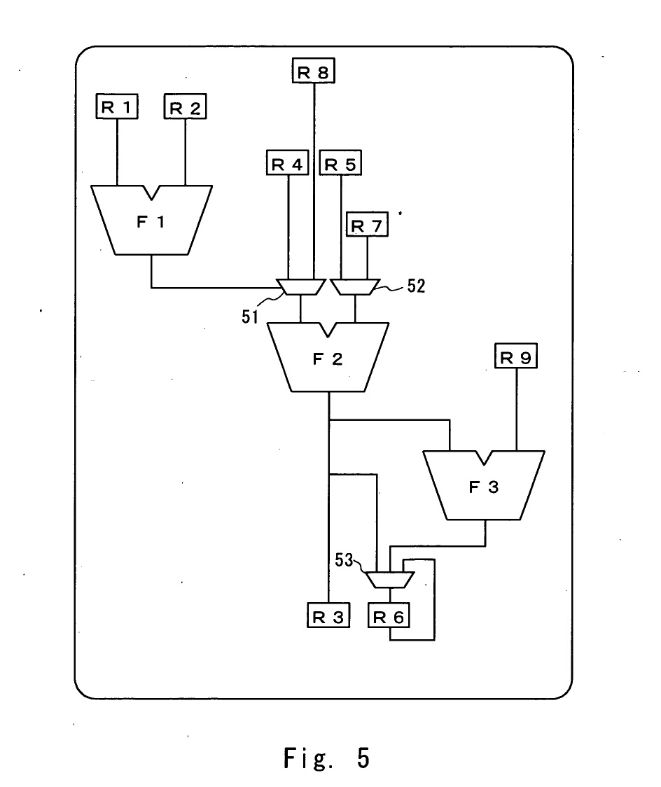

FIG. 5 shows an example of the data path generated from the data flow graph of FIG. 3. The data path is generated in the behavioral synthesis by scheduling and allocation which allocates a computing unit, a register, and a multiplexer and a bus for sharing the computing unit and the register. The data path represents the path of circuits corresponding to the branches and nodes of the data flow graph.

In this example, R1 to R9 are resisters, F1 to F3 are computing units, and 51 to 53 are multiplexers. F1 corresponds to the operation 32 of FIG. 3, F2 corresponds to the operations 33 and 34, and F3 corresponds to the operation 35.

The control circuit of FIG. 3 controls switching of the multiplexers 51 to 53 so that the circuit of the data path operates. For example, in the state ST1, the multiplexers 51 to 53 are switched so that the multiplexer 51 selects the input from R4, the multiplexer 52 selects the input from R7, and the multiplexer 53 selects the input from the computing unit F2, resulting in the operation result of input data to R4 and R7 that is outputted to R6.

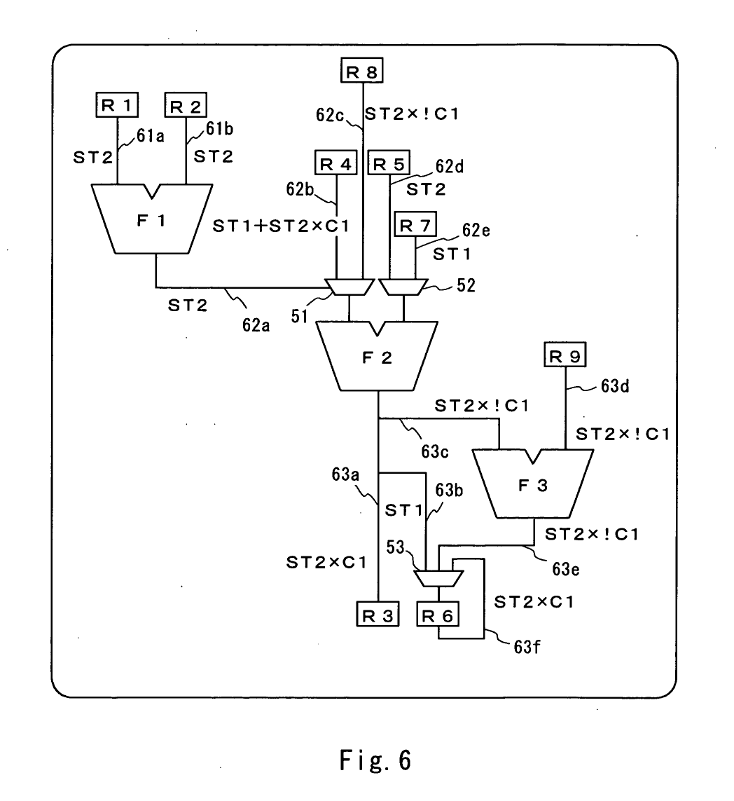

FIG. 6 shows an example of circuit information with active condition where the data path of FIG. 5 is associated with active condition. The active condition is associated with each net of the data path of FIG. 5 based on information on the data flow graph of FIG. 3 and the control circuit of FIG. 4.

In FIG. 6, the reference numerals 61, 62, and 63 designate nets. For example, the net 61a is related to “ST2” as the condition, indicating that this net is activated when the state is ST2. The net 62c is related to “ST2*!C1”, as the condition. The symbol “*” represents AND operation and “!C1” represents the negation of C1, indicating that this net becomes active if the state is ST2 and the operation result C1 of FIG. 3 is false. Further, “ST1+ST2*C1” is conditioned to the net 62b. The symbol “+” represents OR operation, indicating that this net is activated if the state is ST1 or if the state is ST2 and the operation result C1 is true.

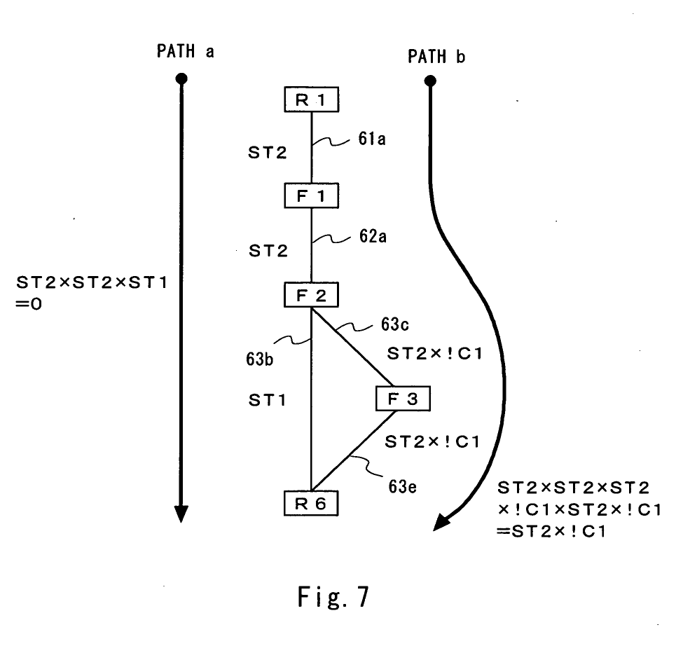

FIG. 7 shows an example of the path between the registers R1 and R6 in FIG. 6. The active conditions of the nets in the path a are: the net 61a is “ST2”, the net 62a is “ST2”, and the net 63b is “ST1”. The result of the AND operation of these active conditions is the active condition of the path a. The states ST2 and ST1 are in different clock cycles and thus do not operate simultaneously. Therefore, the AND of ST1 and ST2 is 0. As a result, the active condition of the path a is ST2*ST2*ST1=0, indicating that the path a is a false path.

The active conditions of the nets in the path b are: the net 61a is “ST2”, the net 62a is “ST2”, the net 63c is “ST2*!C1”, and the net 63e is “ST2*!C1”. Since the comparison operation C1 acts in the state ST2, the AND of ST2 and C1 is not 0. As a result, the active condition of the path b is ST2*ST2*ST2*!C1*ST2*!C1=ST2*!C1, indicating that the path b is a true path. In this way, the circuit information with active condition associates intrinsic active condition with the net even if an alternate path of the net exists.

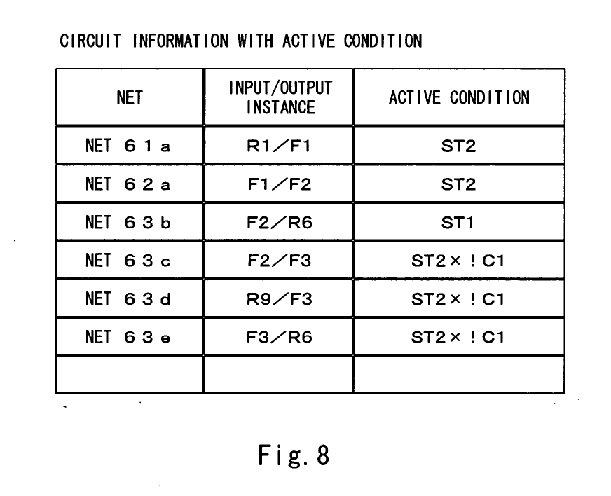

FIG. 8 shows an example of specific data of when the circuit information with active condition of FIG. 7 is stored. The circuit information with active condition includes net identification data, input/output instances of the nets, and active conditions of the nets. For example, in the net 61a, the input instance is associated with R1, the output instance with F1, and the active condition with ST2. Though this example binds data to nets, it is possible to associate data to instances.

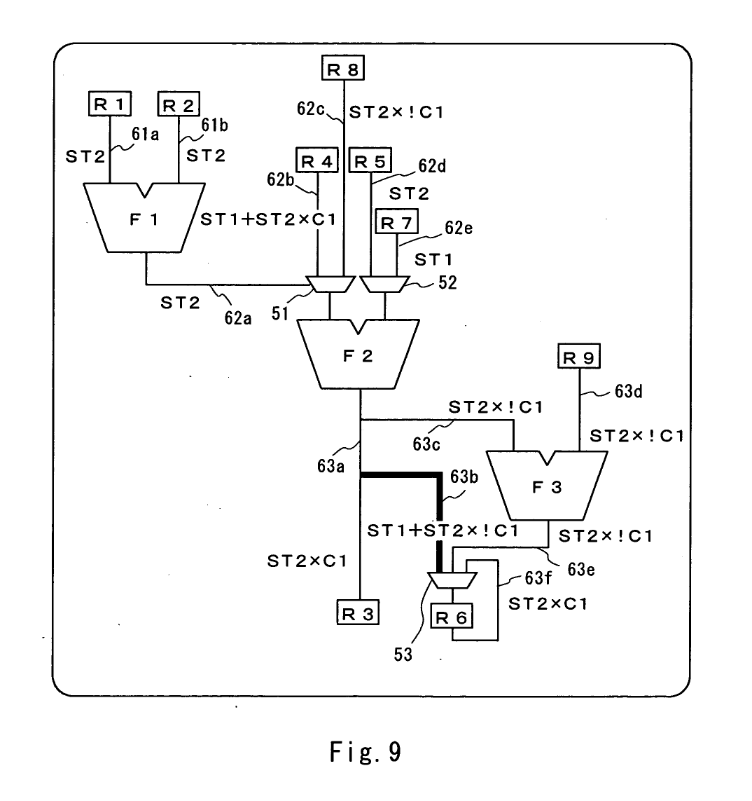

FIG. 9 shows an example of circuit information with alternate path condition in which active condition of an alternate path is added to the circuit information with active condition of FIG. 6. The active condition of the alternate path is added to the active condition of the net by the alternate path condition setting unit 123. In this example, “ST1+ST2*!C1”, which is the condition made by adding the active condition “ST2*!C1” of the nets 63c and 63e, which are alternate paths, to the active condition of the net, is related to the net 63b shown by the heavy line. The OR of the net active condition and the alternate path active condition thus is the active condition of the net.

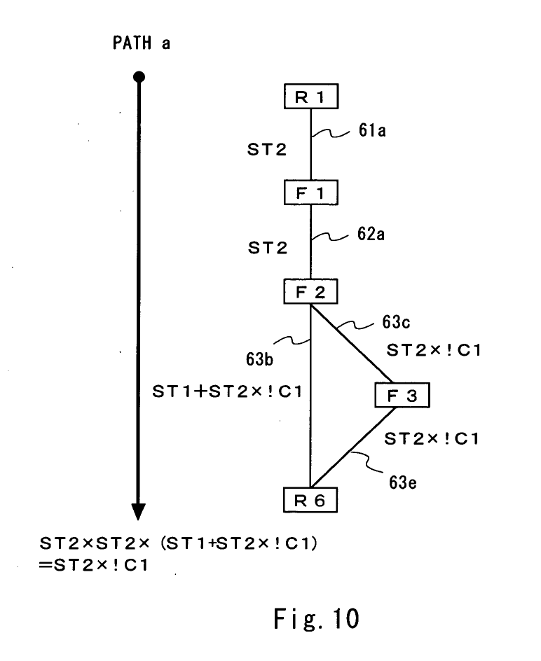

FIG. 10 shows an example of the path between the resisters R1 and R6 of FIG. 9. This is different from FIG. 7 in that the active condition of the alternate path is added to the active condition of the net 63b, which results in “ST1+ST2*!C1”. The active condition of the path a is thereby ST2*ST2*(ST1+ST2*!C1)=ST2*!C1, indicating that the path a is a true path, unlike FIG. 7.

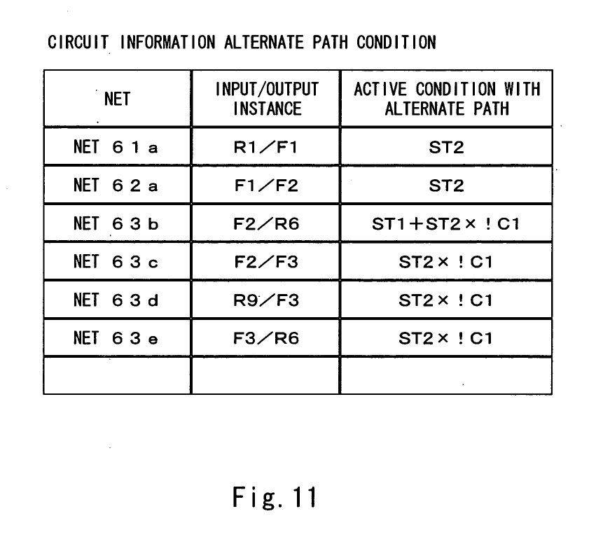

FIG. 11 shows an example of specific data when circuit information with alternate path condition of FIG. 10 is stored. The circuit information with active condition includes net identification data, input/output instances of the nets, and active conditions of the nets with alternate path. This is the same as in FIG. 8 except that the active condition of the alternate path is added to the active condition.

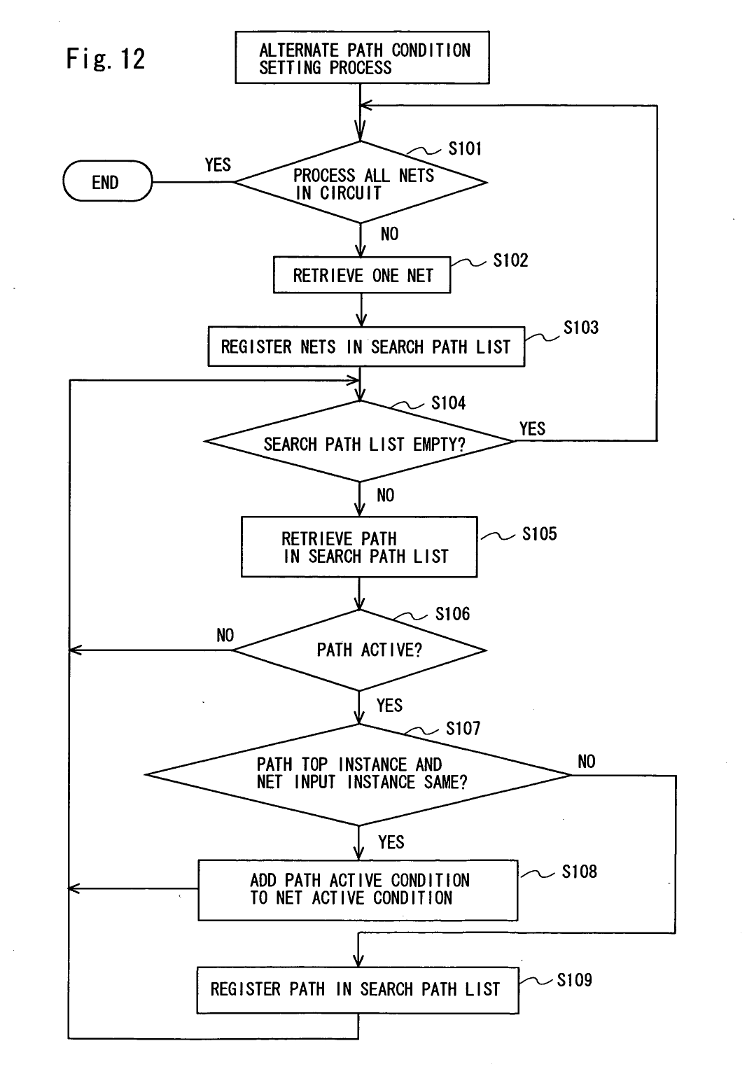

Referring then to the flowchart of FIG. 12, an alternate path condition setting process according to the first embodiment of the invention is described. This process is performed in the alternate path condition setting unit 123 and implemented by an application program executed by CPU or the like, for example.

First, the alternate path condition setting unit 123 determines if all the nets in the circuit have been processed (S101). It is determined whether the process from S102 has been performed on all the nets in the circuit information with active condition stored in the circuit information with active condition storage unit 122. For example, in the case of FIG. 8, it is determined whether all the nets 61a to 63e have been processed.

If it is determines at the step S101 that all the nets have been processed, the alternate path condition setting process ends.

If, on the other hand, the step S101 determines that an unprocessed net remains, the alternate path condition setting unit 123 retrieves one net in the circuit (S102). It reads out the data of one of the nets in the circuit information with active condition stored in the circuit information with active condition storage unit 122 and performs the process of S103 and subsequent steps on the net. If there are the nets on which the process from S103 has been performed already, it reads out the data of the net which is unprocessed. The sequence of reading out the net from the circuit information with active condition may be arbitrary.

For example, in the example of FIG. 8, the data of the net 63b is read out if the net 63b is unprocessed, and the data of the next net 63c is read out if the net 63b is already processed. A case of reading out the data of the net 63b is described hereafter.

Then, the alternate path condition setting unit 123 registers all the nets connected to the input side of the output instance of the target net (read out net at S102) into a search path list (S103). Then, it refers to the output instance of the target net in the data read out in the step S102. Further, it acquires all the nets connected to the input side of the output instance from the circuit information with active condition. Then, the alternate path condition setting unit 123 registers all the acquired nets into the search path list.

Though this example searches for an alternate path by connecting nets to the input side of the output instance, it is also possible to search for an alternate path in the opposite direction by connecting nets to the output side of the input instance of the target net.

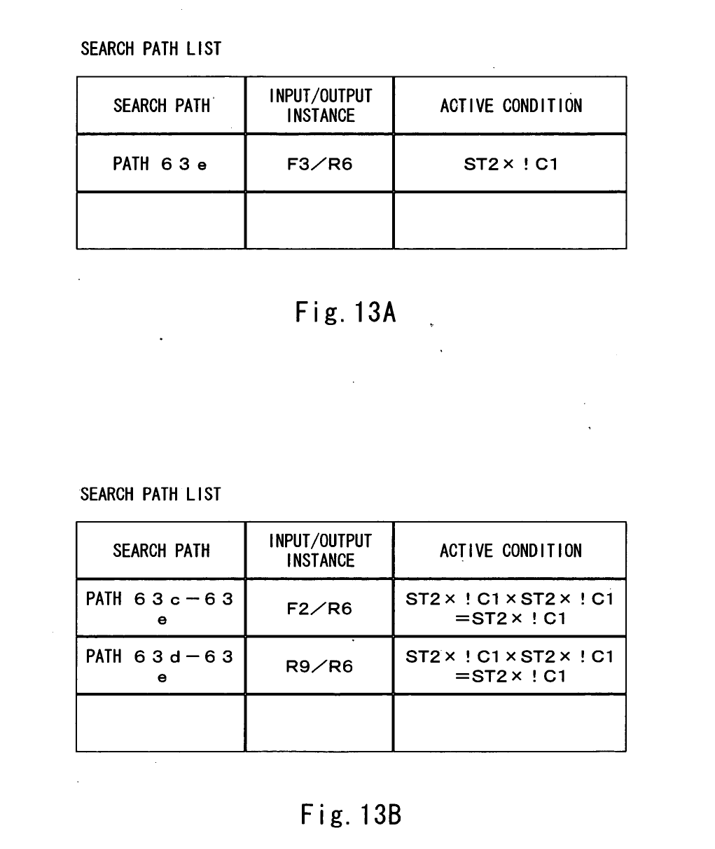

For example, referring the data of the net 63b read out in the step S102, the output instance, that is the instance at the output side, is R6. The nets connected to the input side of R6 are 63b and 63e in the example of the circuit information with active condition of FIG. 8. The net 63b is dropped since it is under processing, and the path 63e, which is the path composed only of the net 63e, is registered into the search path list. A single net is regarded as a path in the search path list. FIG. 13A shows an example of the data of the search path list in this case. The search path list includes a search path to be searched in this process, input/output instances of the search path, and active condition of the search path. In this way, the search path list contains one or more nets and the process from S104 is performed on the registered search paths.

The alternate path condition setting unit 123 then determines if the search path list is empty or not (S104) It determines if the process from S105 is performed on all the paths in the search path list registered in S103 by checking the presence of the path registered in the search path list. For example, since the example of the data of FIG. 13A contains the path 63e, the process from S105 is performed thereon.

If, the step S104 determines that the search path list is empty, the process returns to the step S101 to process the next net. The data of the net which has been processed may be stored in the circuit information with alternate path condition storage unit 124.

If the step S104 determines that the search path list is not empty, the alternate path condition setting unit 123 retrieves a given path in the search path list (S105). It reads out the data of one of the search paths in the search path list registered in S103 and performs the process from S106 on this search path. The data of the path which is read out is deleted from the search path list. For example, in the example of the data of FIG. 13A, the data of the path 63e is read out and deleted from the search path list. The case or reading out the data of the path 63e is described below.

Then, the alternate path condition setting unit 123 determines if the target path is active or not (S106). It refers to the active condition of the search path in the data of the search path read out in S105 and determines if the search path is a true path or a false path. For example, referring to the data of the path 63e read out in SLOS, the active condition is “ST2*!C1”. Thus, the path of the path 63e is determined to be a true path.

If it determines that the target path is a false path at the step S106, the alternate path condition setting unit 123 returns to the step S104 and processes the path registered in the search path list.

If, on the other hand, the step S106 determines that the target path is a true path, the alternate path condition setting unit 123 further determines if the instance at the beginning of the target path is the same as the input instance of the target net (S107). It refers to the input instance of the target path, which is connected at the input side (beginning) of the search path, in the data of the search path read out in S105. Then, it compares the input instance of the search path and the input instance of the target net read out in S102 to determine if they are the same or not.

For example, referring to the data of the path 63e read out in S105, the input instance of the path is F3. The input instance of the net 63b read out in S102 is F2. Therefore, it is determined that the input instance of the target search path and the input instance of the target net 63e are not the same.

If the step S107 determines that the instance at the beginning of the target path is not the same as the instance at the input side of the target net, the alternate path condition setting unit 123 determines that the path is not an alternate path and registers the path composed of the target path and the nets connected to the input side of the target path, into the search path list (S109). After that, the alternate path condition setting unit 123 returns to the step S104 and processes the subsequent path.

Specifically, the alternate path condition setting unit 123 refers to the instance connected to the input side of the search path, which is the input instance, in the data of the search path read out in S105. Then, it acquires all the nets connected to the input side of the input instance from the circuit information with active condition. After that, the alternate path condition setting unit 123 generates new paths composed of the search path and all the acquired nets and registers the new paths into the search path list.

For example, referring to the data of the path 63e read out from S105, the input instance of the path 63e is F3. The nets connected to the input side of F3 are the nets 63c and 63d in the example of the circuit information with active condition of FIG. 8. Thus, the alternate path condition setting unit 123 registers the path 63c to 63e composed of the nets 63c and 63e and the path 63d to 63e composed of the nets 63d and 63e into the search path list. An example of the data of the search path list is described in FIG. 13B. After that, the process from the step S104 is performed on the registered path 63c to 63e and path 63d and 63e.

If, on the other hand, the step S107 determines that the instance at the beginning of the target path is the same as the instance at the input side of the target net, the alternate path condition setting unit 123 determines that the path is an alternate path and adds the active condition of the target path to the active condition of the target net (S108).

Specifically, the alternate path condition setting unit 123 refers to the active condition of the search path in the data of the search path read out in S105. It then adds the active condition of the path to the active condition of the net read out in S102 by OR operation.

For example, when processing the data of the path 63c to 63e of FIG. 13B, the input instance of the path is F2, which is the same as the input instance of the net 63b read out in S102. Therefore, the active condition “ST2*!C1” of the path 63c to 63e is added to the active condition “ST1” of the net 63b by OR operation. The active condition of the net 63b results in thereby “ST1+ST2*!C1” as shown in FIG. 11.

In this way, it is possible to further add the active condition of an alternate path of the net for the net of the data path with active condition.

This configuration allows extracting a false path from a behaviorally synthesized data path and outputting the false path with a specified instance. Particularly, if an alternate path exists corresponding to a net, the active condition of the alternate path is added to the active condition of the net, thereby preventing a true path from being included in paths defined by instances which indicates a false path. Since this configuration assures that all the paths defined by instances are false paths, it is possible to accurately designate the false path. This allows accurate identification of the false path for a netlist generation tool, an STA tool, an automatic placer and router and so on. This eliminates unnecessary timing verification and optimization, thereby improving the efficiency of the design work.

### Second Embodiment

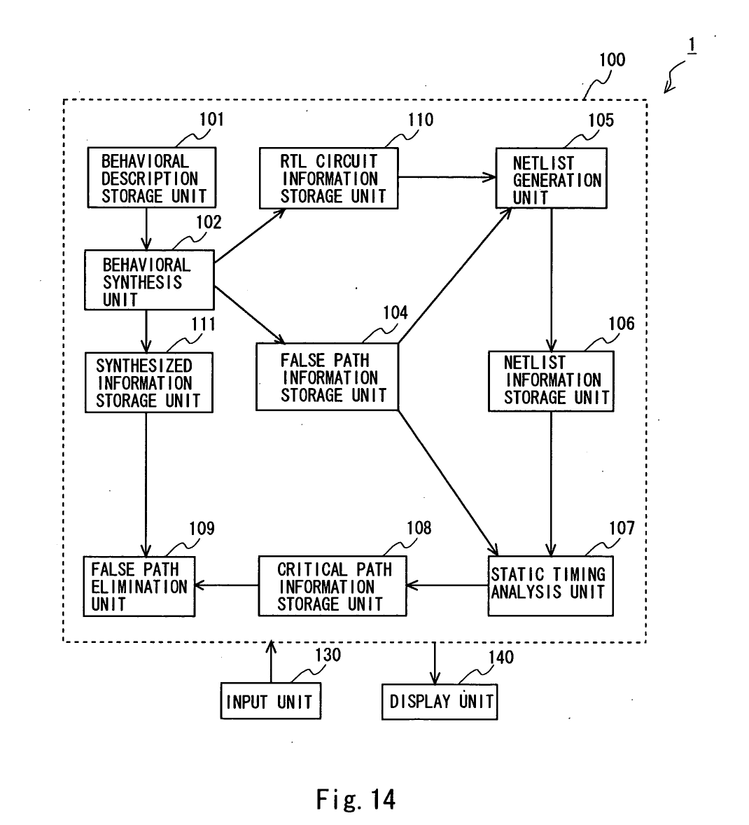

A configuration of a circuit design assistant system according to a second embodiment of the invention is described hereafter with reference to FIG. 14. The circuit design assistant system 1 is the same as the system of FIG. 1, and it performs netlist generation and static timing analysis based on a false path extracted by the same way as in FIG. 1. The circuit design assistant system 1 further removes an unnecessary false path from a delay report obtained as a result of the static timing analysis.

As shown in FIG. 14, the circuit design assistant system 1 has a circuit design support unit 100, an input unit 130, and a display unit 140. The circuit design support unit 100 further has a netlist generation unit 105, a netlist information storage unit 106, a static timing analysis unit 107, a critical path information storage unit 108, a false path elimination unit 109, an RTL circuit information storage unit 110, and a synthesized information storage unit 111 in addition to the elements of FIG. 1.

The behavioral synthesis unit 102 of this embodiment includes the false path extraction unit 120 in FIG. 1. The RTL circuit information storage unit 110 stores an RTL circuit included in the behaviorally synthesized circuit information storage unit 103 of FIG. 1. The synthesized information storage unit 111 stores circuit information similar to the behaviorally synthesized circuit information storage unit 103 of FIG. 1.

The netlist generation unit 105 logically synthesizes the RTL circuit stored in the behaviorally synthesized circuit information storage unit 103 to generate a netlist which can be subject to static timing analysis and store it into the netlist information storage unit 106. The netlist generation unit 105 may not perform optimization of the circuit corresponding to the false path with specified instance stored in the false path information storage unit 104. This allows a reduction in a logic synthesis processing time.

The netlist generation unit 105 may output the netlist to the display unit 141 or another device.

The static timing analysis unit 107 analyzes and verifies static timing characteristics of a netlist from the netlist information storage unit 106 to extract a critical path, referred to as a delay path, which does not satisfy delay constraints and to store a delay report including a plurality of critical paths into the critical path information storage unit 108. The static timing analysis unit 107 may not perform the timing verification on the false path defined by instances stored in the false path information storage unit 104. For the false path may not be outputted as a critical path even if it has a delay error.

The false path elimination unit 109 analyzes the critical path stored in the critical path information storage unit 108 to remove the false path included in the critical path and output the critical path from which the false path has been eliminated to the display unit 140. The false path elimination unit 109 serves as a circuit information acquiring section which acquires circuit information generated by behavioral synthesis and delay information (delay report) generated from the circuit information by timing verification. It also serves as an active condition determination section which determines the active condition of each critical path included in delay information, as a false path detection section which determines if each critical path is a false path based on the active condition, and as a false path elimination section which eliminates the critical path determined to be a false path from the delay information

The false path elimination unit 109 processes all the critical paths stored in the critical path information storage unit 108. First, it reads out a critical path stored in the critical path information storage unit 108. Then, it determines if the critical path is a false path or not. To determine this, it may acquires the active condition of each net constituting the critical path from the synthesized information storage unit 111 and perform AND operation of the active conditions of the nets, for example. If the critical path is a false path, it is eliminated from the critical path information storage unit 108. After eliminating all the critical paths determined as a false path from the critical path information storage unit 108, the false path elimination unit 109 outputs the critical path information storage unit 108 to the display unit 140. It is also possible to output the data from which the false path is eliminated only to the display unit 140 without directly deleting the data of the critical path information storage unit 108.

Though this example eliminates the false path from the critical path based on the information of the synthesized information storage unit 111 including the same circuit information as the behaviorally synthesized circuit information storage unit 103, it is possible to eliminate the false path based on other information. For example, the false path may be eliminated from the critical path based on the information of the circuit information with active condition storage unit 122 or the circuit information with alternate path condition storage unit 124 of FIG. 1.

This configuration allows detecting a critical path corresponding to a false path based on information outputted from the behavioral synthesis unit or the false path extraction unit and eliminating the critical path from a delay report even if the false path information storage unit 104 does not include all the false paths. It is thus possible to generate the delay report which does not include any false path, thereby improving the accuracy of the delay report.

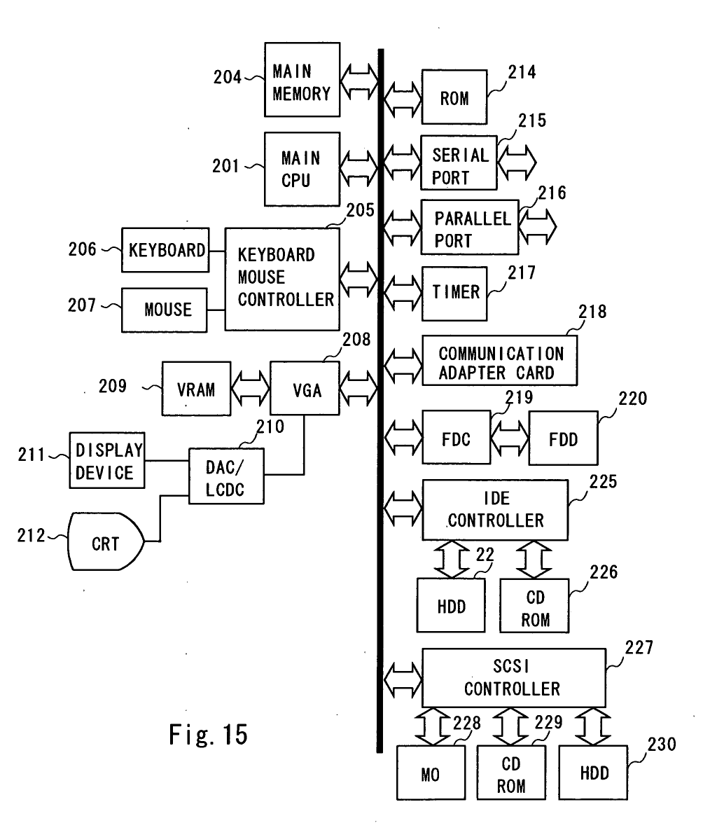

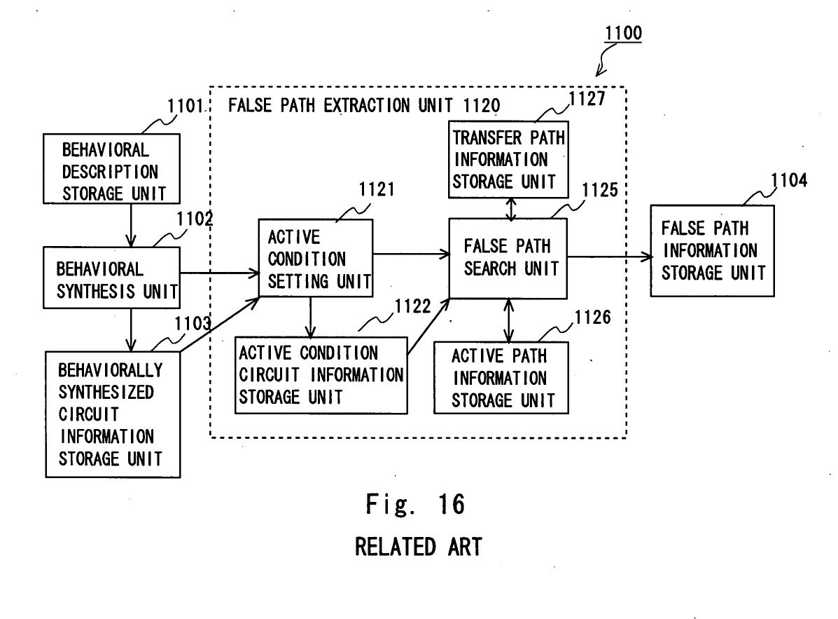

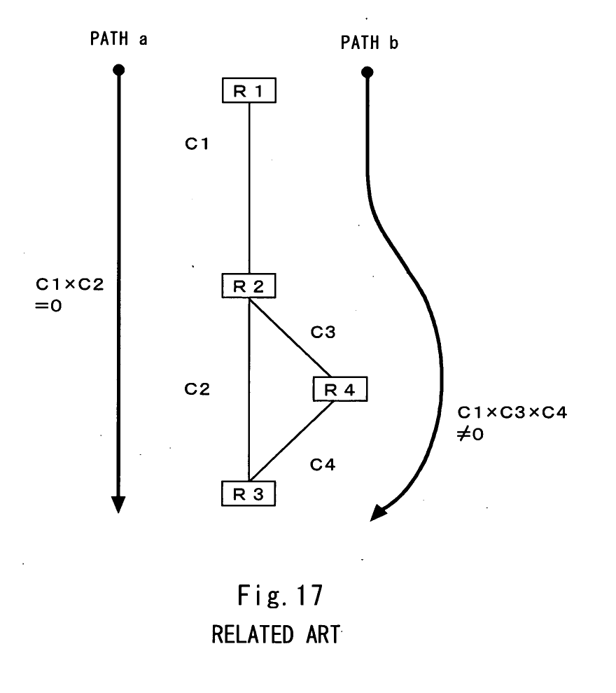

FIG. 15 shows an example of the hardware configuration for implementing the circuit design assistant system 1. The circuit design assistant system 1 may be a typical computer system including a CPU 201 and a memory 204.

The CPU 201 and the memory 204 are connected to a hard disk device 213 as an auxiliary memory unit via a bus. Storage medium drive devices such as a flexible disk device 220, hard disk devices 213, 230, CD-ROM drives 226, 229, and an MO drive 228 are connected to the bus via various control circuits such as a flexible disk control circuit 210, an IDE control circuit 225, and an SCSI control circuit 227. A portable storage medium such as a flexible disk is inserted to the storage medium drive device such as the flexible disk device 220.

The storage medium may store computer program which gives instructions to the CPU 201 or the like in collaboration with an operation system to implement the functions of the circuit design assistant system 1. The computer program is executed by being loaded to the memory 204. The computer program may be compressed or divided into a plurality of portions and stored in the storage medium. The hardware configuration typically has an user interface hardware.

The user interface hardware involves a pointing device such as a mouse 207 or a joy stick and a keyboard 206 for inputting data, a display device 211 such as a liquid crystal display or a CRT display 212 for displaying visual data for the user, for example.

Further, the computer system may connect a printer via a parallel port 216. It may further connect a modem via a serial port 215. The computer system is connected to the network via the serial port 215 and the modem or a token ring, a communication adapter 218, and so on, thereby communicating data with other computer systems. The above elements may be eliminated as needed.

It is apparent that the present invention is not limited to the above embodiment that may be modified and changed without departing from the scope and spirit of the invention.

1. A computer program product, in a computer readable medium, which causes a computer to execute a process of detecting a false path from a data path having a plurality of paths including a plurality of transfer paths, the process comprising:
acquiring circuit information generated by behavioral synthesis and a data path corresponding to the circuit information;
determining an active condition for transferring data for each of the plurality of transfer paths included in the data path based on the circuit information;
determining an active condition of an alternate path bypassing a transfer path and transferring data for each of the plurality of transfer paths based on the active conditions of the transfer paths;
determining an active condition of an alternate data path composed of a transfer path and an alternate path of the transfer path based on the active condition of the transfer path and the active condition of the alternate path;
determining an active condition of each of a plurality of paths included in the data path based on the active condition of the transfer path and the active condition of the alternate data path; and
detecting a false path based on the active condition of the path.

2. The computer program product of claim 1, wherein
the circuit information includes data flow graph and instance allocation information, and
the active condition of the transfer path is determined in accordance with a state of the data flow graph associated with the data path by the instance allocation information.

3. The computer program product of claim 1, wherein the determining the active condition of the alternate path comprises:
searching a path including an instance at an input side and an instance at an output side of each of the plurality of transfer paths from the data path, and determining an alternate path of the transfer path, and
determining an active condition of the alternate path based on an active condition of the transfer path included in the alternate path.

4. The computer program product of claim 2, wherein the determining the active condition of the alternate path comprises:
searching a path including an instance at an input side and an instance at an output side of each of the plurality of transfer paths from the data path, and determining an alternate path of the transfer path, and
determining an active condition of the alternate path based on an active condition of the transfer path included in the alternate path.

5. The computer program product of claim 1, wherein
the active condition of the alternate path is AND of active conditions of a plurality of transfer paths included in the alternate path,
the active condition of the alternate data path is OR of an active condition of a transfer path included in the alternate data path and an active condition of an alternate path included in the alternate data path,
the active condition of the plurality of paths is AND of active conditions of a plurality of transfer paths included in the plurality of paths and active conditions of a plurality of alternate data paths included in the plurality of paths, and
the false path is detected by determining a path as a false path if logical operation of the active condition of the path is 0.

6. The computer program product of claim 2, wherein
the active condition of the alternate path is AND of active conditions of a plurality of transfer paths included in the alternate path,
the active condition of the alternate data path is OR of an active condition of a transfer path included in the alternate data path and an active condition of an alternate path included in the alternate data path,
the active condition of the plurality of paths is AND of active conditions of a plurality of transfer paths included in the plurality of paths and active conditions of a plurality of alternate data paths included in the plurality of paths, and
the false path is detected by determining a path as a false path if logical operation of the active condition of the path is 0.

7. The computer program product of claim 3, wherein
the active condition of the alternate path is AND of active conditions of a plurality of transfer paths included in the alternate path,
the active condition of the alternate data path is OR of an active condition of a transfer path included in the alternate data path and an active condition of an alternate path included in the alternate data path,
the active condition of the plurality of paths is AND of active conditions of a plurality of transfer paths included in the plurality of paths and active conditions of a plurality of alternate data paths included in the plurality of paths, and
the false path is detected by determining a path as a false path if logical operation of the active condition of the path is 0.

8. The computer program product of claim 1 further comprising outputting the detected false path indicated by a plurality of instances included in the false path.

9. The computer program product of claim 2 further comprising outputting the detected false path indicated by a plurality of instances included in the false path.

10. The computer program product of claim 3 further comprising outputting the detected false path indicated by a plurality of instances included in the false path.

11. The computer program product of claim 5 further comprising outputting the detected false path indicated by a plurality of instances included in the false path.

12. A computer program product, in a computer readable medium, which causes a computer to execute a process of eliminating a false path from delay information including a plurality of critical paths, the process comprising:
acquiring circuit information generated by behavioral synthesis and delay information generated from the circuit information by timing verification;
determining an active condition for transferring data for each of the plurality of critical paths included in the delay information based on the circuit information;
determining whether each critical path is a false path based on the active condition; and
eliminating the critical path from the delay information if the critical path is a false path.

13. A design method for detecting a false path from a data path having a plurality of paths including a plurality of transfer paths, the method comprising:
acquiring circuit information generated by behavioral synthesis and a data path corresponding to the circuit information;
determining an active condition for transferring data for each of the plurality of transfer paths included in the data path based on the circuit information;
determining an active condition of an alternate path bypassing a transfer path and transferring data for each of the plurality of transfer paths based on the active conditions of the transfer paths;
determining an active condition of an alternate data path composed of a transfer path and an alternate path of the transfer path based on the active condition of the transfer path and the active condition of the alternate path;
determining an active condition of each of a plurality of paths included in the data path based on the active condition of the transfer path and the active condition of the alternate data path; and
detecting a false path based on the active condition of the path.

14. The design method of claim 13, wherein
the circuit information includes data flow graph and instance allocation information, and
the active condition of the transfer path is determined in accordance with a state of the data flow graph associated with the data path by the instance allocation information.

15. The design method of claim 13, wherein the determining the active condition of the alternate path comprises:
searching a path including an instance at an input side and an instance at an output side of each of the plurality of transfer paths from the data path, and determining an alternate path of the transfer path, and
determining an active condition of the alternate path based on an active condition of the transfer path included in the alternate path.

16. The design method of claim 13, wherein
the active condition of the alternate path is AND of active conditions of a plurality of transfer paths included in the alternate path,
the active condition of the alternate data path is OR of an active condition of a transfer path included in the alternate data path and an active condition of an alternate path included in the alternate data path,
the active condition of the plurality of paths is AND of active conditions of a plurality of transfer paths included in the plurality of paths and active conditions of a plurality of alternate data paths included in the plurality of paths, and
the false path is detected by determining a path as a false path if logical operation of the active condition of the path is 0.

17. The design method of claim 13 further comprising outputting the detected false path indicated by a plurality of instances included in the false path.

18. A design method for eliminating a false path from delay information including a plurality of critical paths, the method comprising:
acquiring circuit information generated by behavioral synthesis and delay information generated from the circuit information by timing verification;
determining an active condition for transferring data for each of the plurality of critical paths included in the delay information based on the circuit information;
determining whether each critical path is a false path based on the active condition; and
eliminating the critical path from the delay information if the critical path is a false path.

19. A circuit design assistant system for detecting a false path from a data path having a plurality of paths including a plurality of transfer paths, the system comprising:
a circuit information acquiring unit of acquiring circuit information generated by behavioral synthesis and a data path corresponding to the circuit information;
a transfer path active condition determination unit of determining an active condition for transferring data for each of the plurality of transfer paths included in the data path based on the circuit information;
an alternate path active condition determination unit of determining an active condition of an alternate path bypassing a transfer path and transferring data for each of the plurality of transfer paths based on the active condition of the transfer path;
an alternate data path active condition determination unit of determining an active condition of an alternate data path composed of a transfer path and an alternate path of the transfer path based on the active condition of the transfer path and the active condition of the alternate path;
a path active condition determination unit of determining an active condition of each of a plurality of paths included in the data path based on the active condition of the transfer path and the active condition of the alternate data path; and
a false path detection unit of detecting a false path based on the active condition of the path.

20. A circuit design assistant system for eliminating a false path from delay information including a plurality of critical paths, the system comprising:
a circuit information acquiring unit of acquiring circuit information generated by behavioral synthesis and delay information generated from the circuit information by timing verification;
an active condition determination unit of determining an active condition for transferring data for each of the plurality of critical paths included in the delay information based on the circuit information;
a false path detection unit of detecting whether each critical path is a false path based on the active condition; and
a false path elimination unit of eliminating the critical path from the delay information if the critical path is a false path.
